(19) United States
(12) Patent Application Publication
(10) Pub. No.: US 2024/0078651 A1
(43) Pub. Date: Mar. 7, 2024

(54) ASSESSMENT DEVICE AND ASSESSMENT METHOD

(71) Applicant: Panasonic Intellectual Property Management Co., Ltd., Osaka (JP)

(72) Inventor: Shoichi Araki, Osaka (JP)

(21) Appl. No.: 18/501,084

(22) Filed: Nov. 3, 2023

Related U.S. Application Data
(63) Continuation of application No. PCT/JP2022/019898, filed on May 11, 2022.

(30) Foreign Application Priority Data
May 28, 2021 (JP) 2021-090237

(51) Int. Cl. G06T 7/00; G01S 17/08

(52) U.S. Cl. CPC G06T 7/0002; G01S 17/08

(57) ABSTRACT

An assessment device (10) includes a camera (12) that captures an image showing a component to which a target object is attached to cover the surface of the component, a distance measuring sensor (13) that measures the distance to the component, and an information processor (16). The information processor (16) performs: a first process of assessing whether the target object attached to the component is a predetermined object meant to be attached to the component by applying a first assessment model to the image captured by the camera (12) while the distance measured by the distance measuring sensor (13) is within a first distance range; and a second process of assessing whether the target object is in acceptable condition by applying a second assessment model to the image captured by the camera (12) while the distance measured by the distance measuring sensor (13) is within a second distance range.

### CROSS REFERENCE TO RELATED APPLICATIONS

This is a continuation application of PCT International Application No. PCT/JP2022/019898 filed on May 11, 2022, designating the United States of America, which is based on and claims priority of Japanese Patent Application No. 2021-090237 filed on May 28, 2021. The entire disclosures of the above-identified applications, including the specifications, drawings, and claims are incorporated herein by reference in their entirety.

### FIELD

The present disclosure relates to assessment devices and assessment methods.

### BACKGROUND

A technique of using images obtained by capturing a target object in order to, for example, inspect the target object is known. The image processing device disclosed in Patent Literature (PTL) 1 can be used to realize a user interface applicable to such a technique.

### CITATION LIST

### Patent Literature

PTL 1: Japanese Unexamined Patent Application Publication No. 2012-213063

### SUMMARY

### Technical Problem

The present disclosure provides an assessment device and an assessment method that can use an image to make a plurality of types of assessments depending on the distance to the target object at the time of capturing the image.

### Solution to Problem

An assessment device according to one aspect of the present disclosure includes: a camera that captures an image showing a component to which a target object is attached to cover a surface of the component; a distance measuring sensor that measures a distance to the component; and an information processor. The information processor performs: a first assessment process of assessing whether the target object attached to the component is a predetermined object meant to be attached to the component by applying a first assessment model to an image captured by the camera while the distance measured by the distance measuring sensor is within a first distance range; and a second assessment process of assessing whether the target object is in acceptable condition by applying a second assessment model different than the first assessment model to an image captured by the camera while the distance measured by the distance measuring sensor is within a second distance range different from the first distance range.

An assessment method according to one aspect of the present disclosure includes: assessing whether a target object attached to a component to cover a surface of the component is a predetermined object meant to be attached to the component by applying a first assessment model to an image showing the component captured by a camera while a distance to the component measured by a distance measuring sensor is within a first distance range; and assessing whether the target object is in acceptable condition by applying a second assessment model different than the first assessment model to an image showing the component captured by the camera while a distance to the component measured by the distance measuring sensor is within a second distance range.

A recording medium according to one aspect of the present disclosure is a non-transitory computer-readable recording medium having recorded thereon a program for causing a computer to execute the above assessment method.

### Advantageous Effects

The assessment device and the assessment method according to one aspect of the present disclosure can use an image to make a plurality of types of assessments depending on the distance to the target object at the time of capturing the image.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1A is a first diagram for illustrating an overview of an assessment device according to one embodiment.

FIG. 1B is a second diagram for illustrating an overview of the assessment device according to one embodiment.

FIG. 2 is a block diagram illustrating the functional structure of the assessment device according to one embodiment.

FIG. 3 illustrates one example of inspection information stored in storage included in the assessment device according to one embodiment.

FIG. 4 illustrates one example of a floor plan of a room to be inspected.

FIG. 5 is a flowchart of an operation example of the assessment device according to one embodiment.

FIG. 6 illustrates one example of a display showing information instructing a user to capture an image from within a first distance range.

FIG. 7 illustrates an example of set identification regions.

FIG. 8 illustrates one example of classification scores.

FIG. 9 illustrates one example of a screen displaying the assessment result of a part number assessment.

FIG. 10 illustrates another example of a screen displaying the assessment result of a part number assessment.

FIG. 11 illustrates one example of the display showing information instructing a user to capture an image from within a second distance range.

FIG. 12 illustrates one example of a screen displaying the assessment result of a finish assessment.

FIG. 13 illustrates another example of a screen displaying the assessment result of a finish assessment.

### DESCRIPTION OF EMBODIMENT(S)

### Underlying Knowledge Forming Basis of Present Disclosure

Techniques for inspecting interior materials that have been installed in a building by capturing images of them are known. Such inspections include part number inspections, which examine whether the correct interior materials are installed, and finish inspections, which examine the interior materials for scratches and other defects.

Typically, the part number inspection and the finish inspection are performed separately, which requires the user to make two passes through the building to perform both the part number and finish inspections. Performing both the part number inspection and the finish inspection in one pass requires complicated work such as switching the screen of the inspection device and switching which inspection devices are brought along.

The present disclosure provides an assessment device and an assessment method that can reduce total inspection time by performing both the part number inspection and the finish inspection in one pass.

An assessment device according to one aspect of the present disclosure includes: a camera that captures an image showing a component to which a target object is attached to cover a surface of the component; a distance measuring sensor that measures a distance to the component; and an information processor. The information processor performs: a first assessment process of assessing whether the target object attached to the component is a predetermined object meant to be attached to the component by applying a first assessment model to an image captured by the camera while the distance measured by the distance measuring sensor is within a first distance range; and a second assessment process of assessing whether the target object is in acceptable condition by applying a second assessment model different than the first assessment model to an image captured by the camera while the distance measured by the distance measuring sensor is within a second distance range different from the first distance range.

For example, the assessment device further includes a display. For example, the information processor identifies the component based on the distance measured by the distance measuring sensor and the image captured by the camera. For example, based on the component identified, at least one of information instructing a user to capture the image from within the first distance range or information instructing the user to capture the image from within the second distance range is displayed on the display.

For example, the assessment device further includes storage. For example, the information processor: after identifying the component, identifies the predetermined object meant to be attached to the component by referring to the storage; and in the first assessment process, assesses whether the target object attached to the component is the predetermined object identified or not.

For example, the assessment device further includes storage. For example, the information processor stores, in the storage, identification information of an identified component in association with at least one of an assessment result of the first assessment process or an assessment result of the second assessment process.

For example, the assessment device further includes a light source that illuminates the target object when the camera captures the image.

For example, the target object is an interior material, and the component is any one of a floor, a wall, a ceiling, or a fixture.

An assessment method according to one aspect of the present disclosure includes: assessing whether a target object attached to a component to cover a surface of the component is a predetermined object meant to be attached to the component by applying a first assessment model to an image showing the component captured by a camera while a distance to the component measured by a distance measuring sensor is within a first distance range; and assessing whether the target object is in acceptable condition by applying a second assessment model different than the first assessment model to an image showing the component captured by the camera while a distance to the component measured by the distance measuring sensor is within a second distance range.

A recording medium according to one aspect of the present disclosure is a non-transitory computer-readable recording medium having recorded thereon a program for causing a computer to execute the above assessment method.

Hereinafter, embodiments of the present disclosure will be described with reference to the figures. Each of the embodiments described below is a general or specific example. The numerical values, shapes, materials, elements, arrangement and connection of the elements, steps, order of the steps, etc., indicated in the following embodiments are mere examples and are not intended to limit the present disclosure. Therefore, among elements in the following embodiments, those not recited in any one of the independent claims are described as optional elements.

The figures are schematic diagrams and are not necessarily precise depictions. In the figures, elements having essentially the same configuration share like reference signs, and duplicate description may be omitted or simplified.

### Embodiment

### Overview

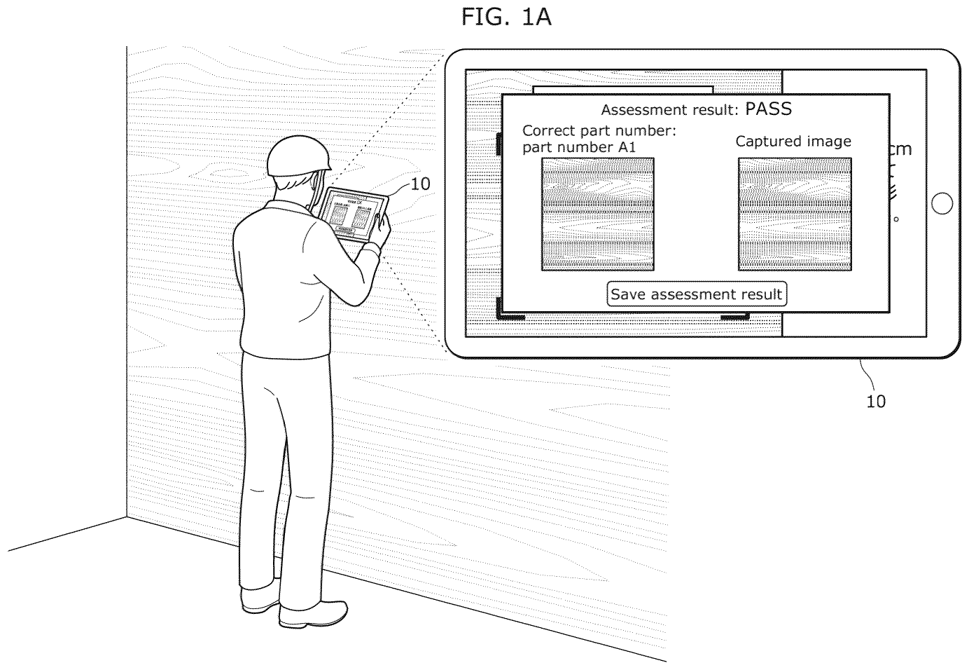

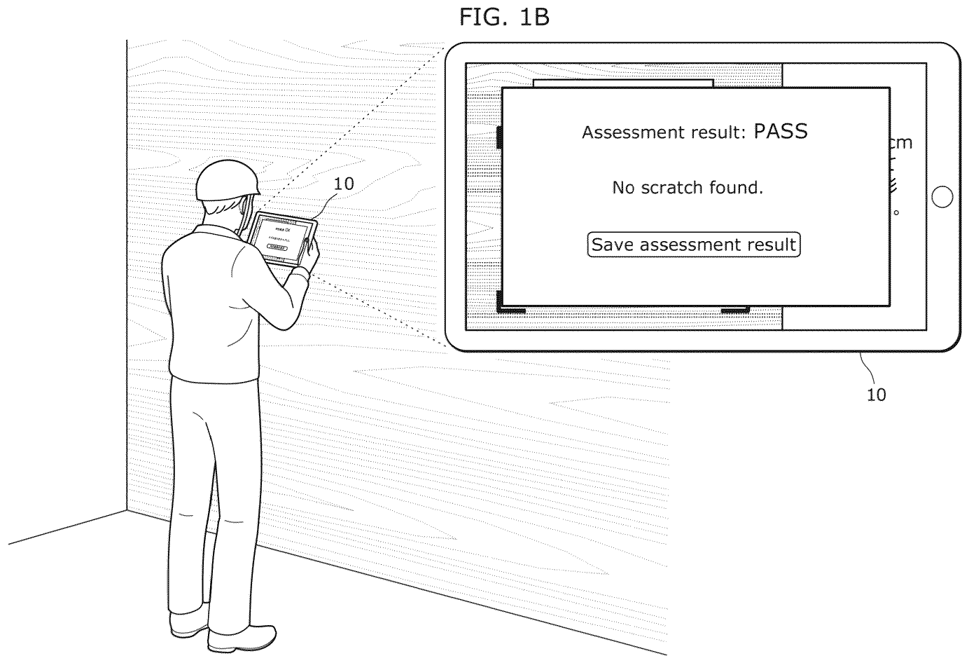

First, an overview of the assessment device according to one embodiment will be described. FIG. 1A and FIG. 1B illustrate an overview of the assessment device according to one embodiment.

As illustrated in FIG. 1A and FIG. 1B, assessment device 10 according to one embodiment is realized as, for example, a tablet terminal, and is used by a user who inspects interior materials. As used herein, inspection of interior materials refers to inspection of whether the correct interior material according to specification has been installed (see FIG. 1A) and inspection of the condition of the interior material (see FIG. 1B).

For example, in the sale of new condominiums, many choices for interior materials such as flooring and wallpaper are offered to accommodate various customer preferences. It is therefore necessary to inspect whether the interior materials specified by the customer have been installed correctly before handing over the residence to the customer. Assessment device 10 is used to inspect such interior materials.

Note that interior materials is a generic term for finishing and base materials used for, but not limited to floors, walls, ceilings, and fixtures. Interior materials include not only finishing materials such as flooring, carpets, tiles, wallpaper, plywood, and painted materials that are directly visible the room, but also the underlying base materials. Interior materials are installed to cover surfaces such as floors, walls, ceilings, and fixtures.

When assessment device 10 obtains, via user operation, an image of a component to which an interior material is attached, it can assess whether the interior material in the image is the predetermined interior material meant to be attached to the component (i.e., is the interior material according to specifications) and whether the interior material in the image is in acceptable condition, and can store (record) the assessment results.

### Configuration

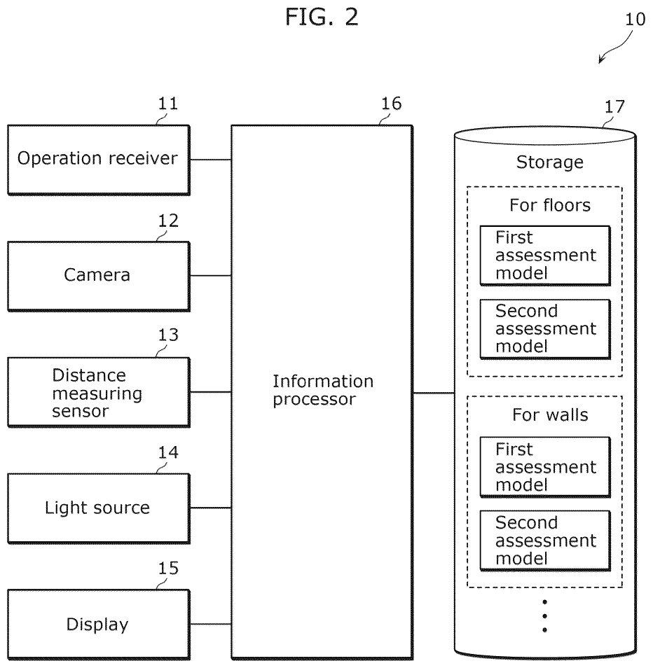

Hereinafter, the configuration of such an assessment device 10 will be described. FIG. 2 is a block diagram illustrating the functional structure of assessment device 10.

As illustrated in FIG. 2, assessment device 10 includes operation receiver 11, camera 12, distance measuring sensor 13, light source 14, display 15, information processor 16, and storage 17.

Assessment device 10 is realized, for example, by installing a specialized application program on a general-purpose portable terminal such as a tablet terminal. Assessment device 10 may be a dedicated device.

Operation receiver 11 accepts user operations. Operation receiver 11 is realized by a touch panel and one or more hardware buttons, for example.

Camera 12 captures an image when operation receiver 11 receives an operation instructing such. Camera 12 is realized, for example, by a complementary metal-oxide semiconductor (CMOS) image sensor. Images obtained by camera 12 are stored in storage 17.

Distance measuring sensor 13 measures the distance from assessment device 10 to a target object (in the present embodiment, the interior material attached to a component in a building). Distance measuring sensor 13 is realized, for example, as a time-of-flight (ToF) light detection and ranging (LiDAR) sensor, but may also be realized by other sensors such as an ultrasonic distance sensor. Distance measuring sensor 13 may be a sensor built into the general-purpose portable terminal, and, alternatively, may be an external sensor connected to the general-purpose portable terminal.

Light source 14 shines light on the target object as camera 12 captures images. Light source 14 is realized by a light-emitting element such as a light-emitting diode (LED), and emits white light. Light source 14 may emit light continuously for a certain period of time as camera 12 captures images, or it may emit light instantaneously in response to an operation instructing capturing of an image.

Display 15 displays a display screen based on control by information processor 16. Display 15 includes, for example, a liquid crystal panel or an organic electroluminescent (EL) panel as a display device.

Information processor 16 performs information processing related to assessing the part number of an interior material (hereinafter referred to as “part number assessment”) and assessing the condition of an interior material (hereinafter referred to as “finish assessment”). Information processor 16 is realized by, for example, a microcomputer, but may be realized by a processor. The functions of information processor 16 are realized by the microcomputer or processor embodying information processor 16 executing a program stored in storage 17.

Storage 17 is a storage device that stores the program that information processor 16 executes to perform the above information processing as well as information necessary for the information processing. Storage 17 is realized, for example, by semiconductor memory.

### Assessment Model

Storage 17 stores, for each component of a room, such as the floor, a wall, the ceiling, or a fixture, a first assessment model for assessing the part number of an interior material attached to the component and a second assessment model for assessing the condition of the interior material.

The first assessment model is a machine learning model that uses images captured a first distance away from target components as training data, is configured to be able to assess the part number of an interior material, and is stored in storage 17 in advance. The images used as training data are labeled with identification information of the interior materials in the images. The identification information of an interior material is, for example, the part number of the interior material, but it may be the product name of the interior material.

Specifically, the first assessment model outputs a classification score based on machine learning, such as a convolutional neural network (CNN). The classification score is a score that indicates which part number the interior material attached to the target component is more likely to be, for example, part number A: 0.60, part number B: 0.20, and so on.

The second assessment model is a machine learning model that uses images captured a second distance away from target components as training data, is configured to be able to assess the condition (finish) of an interior material, and is stored in storage 17 in advance. For example, the condition of the interior material is defined by at least one of whether the interior material is scratched, whether the interior material is stained, or whether the interior material is deformed. As used herein, the term scratch includes, for example, rips, tears, scrapes, slashes, cuts, and scores. For example, images showing interior materials without scratches and images showing the same interior materials but with scratches are used as training data for identifying whether an interior material is scratched. The images used as training data are labeled with information indicating whether the interior material is scratched. The second assessment model is, specifically, constructed based on machine learning, such as a convolutional neural network.

### Overview of Operations

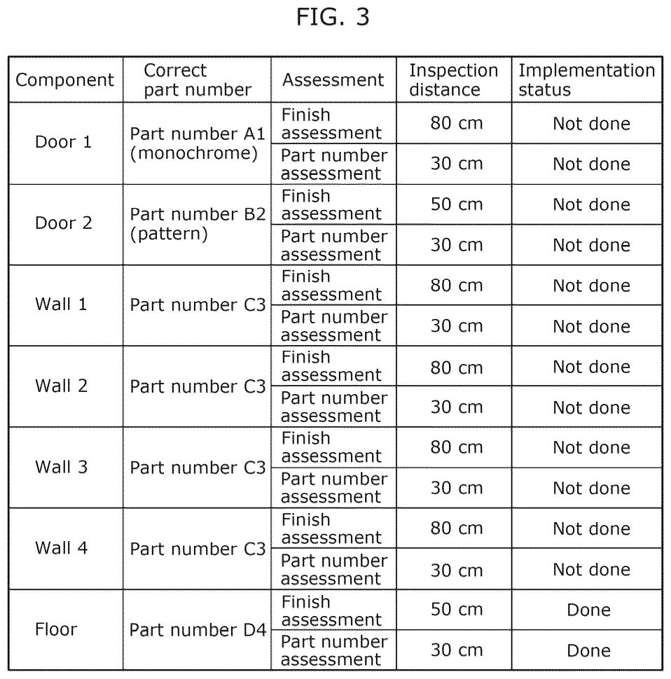

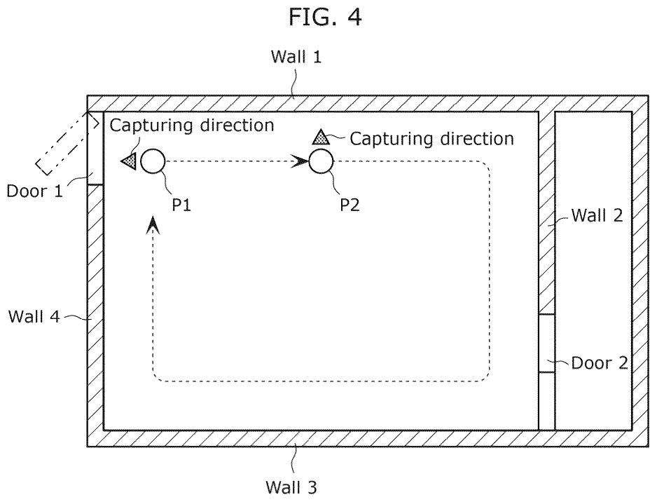

Assessment device 10 can assist the user in efficiently inspecting interior materials. First, an overview of operations of the assessment devices will be described. FIG. 3 illustrates one example of inspection information stored in storage 17 of assessment device 10. FIG. 4 illustrates one example of a floor plan of a room to be inspected.

As illustrated in FIG. 3, in storage 17 of assessment device 10, the identification information of the component of the room to be inspected (such as door 1), the part number of the interior material to be attached to that component (interior material as per specifications), and each assessment to be made for that component are stored in association with one another. In addition, each assessment is stored in association with the suitable imaging distance for the assessment (hereinafter referred to as inspection distance), and whether the assessment has already been made or not (implementation status). Based on such inspection information, assessment device 10 can assist the user in efficiently inspecting interior materials.

For example, as illustrated in FIG. 4, when the user enters the room through door 1 and captures an image of door 1 using assessment device 10 from position P1, assessment device 10 instructs the user with operations corresponding to the assessment or assessments that need to be made on door 1 (in the example in FIG. 3, both the part number assessment and the finish assessment). The black triangles in FIG. 4 indicate the direction in which the image is captured. When the inspection for door 1 is finished and the user moves to position P2 and captures an image of wall 1 using assessment device 10, assessment device 10 instructs the user with operations corresponding to the assessment or assessments that need to be made on wall 1 (in the example in FIG. 3, the part number assessment and the finish assessment).

In this way, the user can easily inspect each component of the room according to instructions from assessment device 10 by entering the room and capturing an image of each component of the room in order. With assessment device 10, the user can make both the part number assessment and the finish assessment in one pass, thereby reducing the total inspection time.

Note that in the example in FIG. 3, although each component is associated with both the part number assessment and the finish assessment as assessments to be made for that component, some components may be associated with only one of the part number assessment or the finish assessment.

### Operation Example

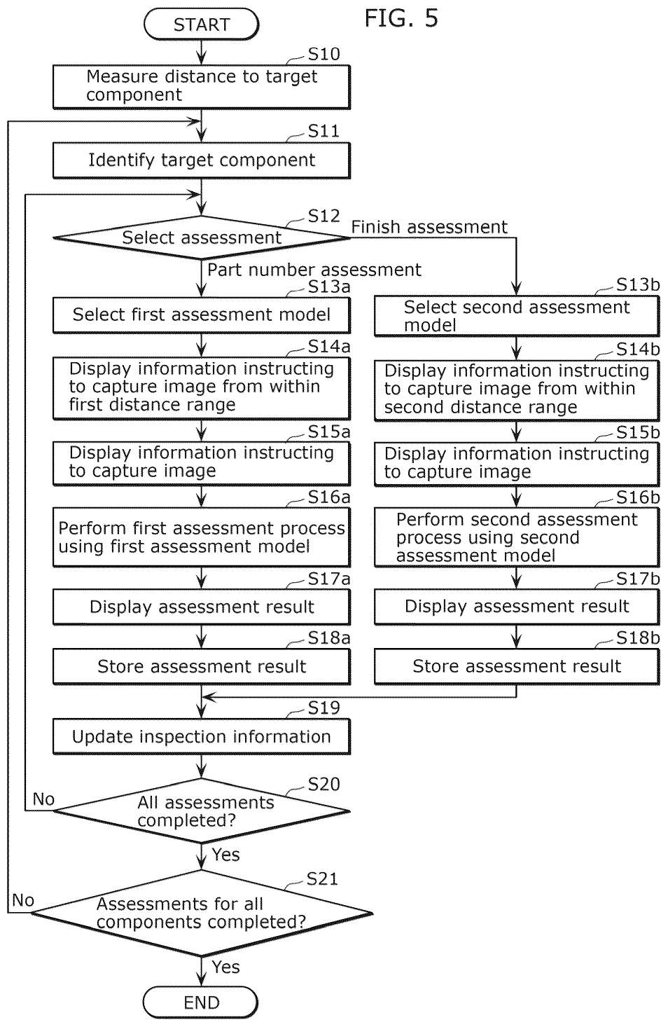

Hereinafter, a specific example of operations of such an assessment device 10 will be described. FIG. 5 is a flowchart of an operation example of assessment device 10.

First, distance measuring sensor 13 of assessment device 10 measures the distance to the component to be assessed (S10). During subsequent processes, the distance from assessment device to the component to be assessed is measured in real time by distance measuring sensor 13. Next, information processor 16 identifies the component (for example, the type of component) to be assessed (S11). For example, information processor 16 uses the distance measured by distance measuring sensor 13 to recognize a plane corresponding to any of the floor, a wall, the ceiling, and a fixture of the room the user is in, and uses features of the image captured by camera 12 to identify which component, i.e., the floor, a wall, the ceiling, or a fixture, the plane being captured is. Hereinafter, the component identified in this way is also referred to as the target component.

When identifying a target component from image features, for example, an identification model constructed to identify components from image features is used. Note that the target component may be specified manually by the user, in which case information processor 16 identifies the target component based on an operation by the user of specifying the component as received by operation receiver 11.

Next, information processor 16 selects the assessment to be made on the identified target component by referring to the inspection information (see FIG. 3) stored in storage 17 (S12). For example, if the identified component is door 1, the assessment with the closest inspection distance from assessment device 10 to the target component at the present time is selected from among the two assessments, namely the part number assessment and the finish assessment, that are associated with door 1 in the inspection information. Note that assessments associated with an implementation status of “done” in the inspection information are excluded from the candidates for selection.

First, the processes performed when the part number assessment is selected in step S12 will be described (i.e., steps S13a through S17a). Information processor 16 selects the first assessment model corresponding to the part number assessment from among the pair of the first and second assessment models corresponding to the target component identified in step S11 (S13a).

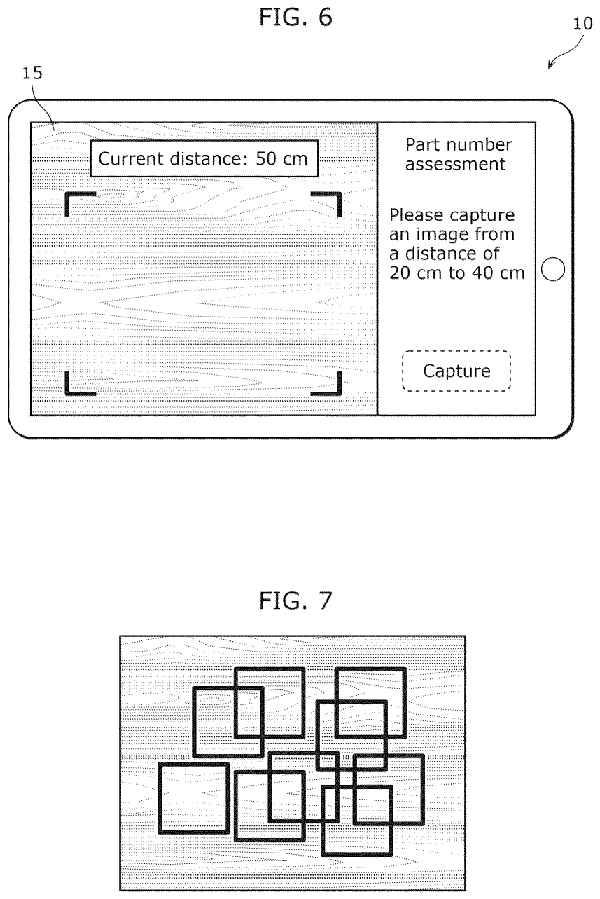

Next, information processor 16 displays, on display 15, the current distance to the target component and information instructing the user to capture an image from within a first distance range suitable for the part number assessment (S14a). FIG. 6 illustrates one example of display 15 showing information instructing the user to capture an image from within the first distance range. When the first distance from the target component to assessment device 10 is d1, the first distance range is d1±a predetermined distance. For example, the first distance range is 30±10 (cm).

When the user moves and the distance to the target component measured by distance measuring sensor 13 enters the first distance range, information processor 16 displays information on display 15 for camera 12 to capture an image of the target component (S15a). For example, an operation button that the user operates to capture an image is displayed on display 15, and information processor 16 causes camera 12 to capture an image showing the target component based on the user tapping the capture button displayed on display 15. When capturing an image, information processor 16 illuminates the target component by emitting light from light source 14.

The operation of the capture button is valid, for example, when the distance to the target component measured by distance measuring sensor 13 is within the first distance range. When the distance to the target component measured by distance measuring sensor 13 is outside the first distance range, the operation of the capture button is invalid. Therefore, in step S15a, the image is captured under the condition that the distance from assessment device 10 to the target component is within the first distance range.

Note that images are not required be captured based on user operation. For example, an image may be automatically captured when the distance to the target component measured by distance measuring sensor 13 falls within the first distance range.

Next, information processor 16 performs a first assessment process of identifying an interior material (color pattern of the target component) attached to the target component, and assessing whether the identification result of the interior material is the correct interior material (correct part number) meant to be attached to that component, by applying the first assessment model selected in step S13a to the image captured in step S15a (S16a). Specifically, information processor 16 sets, for example, a plurality of identification regions in the image captured in step S15a. An identification region corresponds to a portion of the image, and may overlap with other identification regions. FIG. 7 illustrates an example of set identification regions. In FIG. 7, each of the nine rectangular regions in the single image is an identification region. For example, the nine identification regions are set randomly. Note that the number of identification regions given here is merely one example.

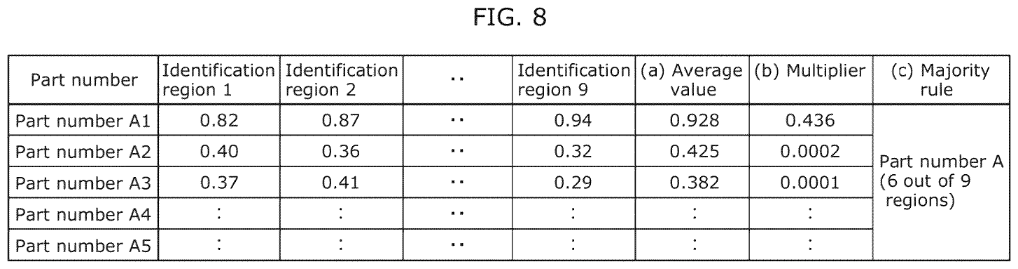

Information processor 16 identifies a classification score for each of the nine identification regions by inputting each of the nine identification regions into the first assessment model (the identification model). FIG. 8 illustrates one example of identified classification scores.

Information processor 16 determines the part number of the interior material attached to the target component based on the classification scores of the nine identification regions. For example, as illustrated in the column “(a) average value” in FIG. 8, information processor 16 determines the part number corresponding to the highest score among the average values of the classification scores of a predetermined number of interior material part numbers (five in the example in FIG. 8) to be the part number of the interior material attached to the target component.

Note that information processor 16 may determine the part number with the highest score among the multipliers of the classification scores of a predetermined number of interior material part numbers to be the part number of the interior material attached to the target component, as illustrated in the column “(b) multiplier” in FIG. 8. Furthermore, information processor 16 may identify the part number with the highest classification score for each of the nine identification regions, aggregate the identified part numbers, and determine the frequency of the most frequent part number to be the part number of the interior material attached to the target component, as illustrated in the column “(c) majority rule” in FIG. 8.

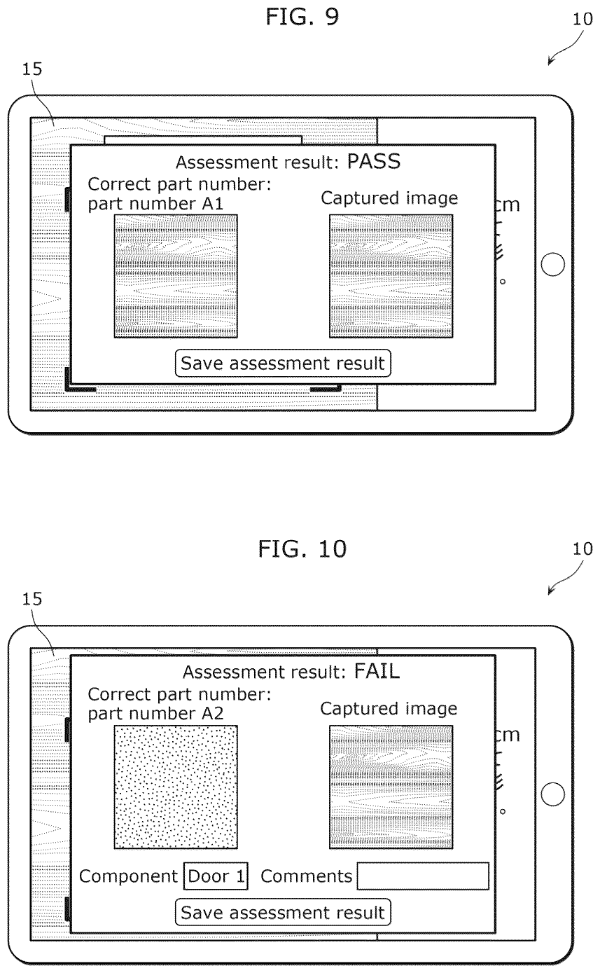

Next, information processor 16 displays the identification result on display 15 (S17a). FIG. 9 illustrates one example of a screen displaying the assessment result. As illustrated in FIG. 9, information processor 16 identifies the correct part number by, for example, referring to the inspection information. The interior material with the correct part number is one example of a predetermined object. Information processor 16 assesses whether the part number determined in step S16a is the identified correct part number, and if it is, information processor 16 displays that the correct interior material has been installed on display 15.

In the first assessment process, the first assessment model outputs the classification score of each of a plurality of interior materials, but the first assessment model may be constructed to output only the classification score of the interior material with the correct part number. Such a first assessment model is constructed, for example, by learning only images that show the correct interior material meant to be attached to the target component as training data. When such a first assessment model is used, in step S16a, if the classification score is higher than a predetermined value, display indicates that the correct interior material is installed.

As illustrated in FIG. 9, a thumbnail of the correct part number and a thumbnail of the image captured in step S15a may be displayed side by side on the screen displaying the assessment result. This allows the user to also visually assess whether the correct interior material is installed.

However, if information processor 16 assesses that the part number determined in step S16a is different from the correct part number, information processor 16 displays that the correct interior material has not been installed on display 15. FIG. 10 illustrates another example of a screen displaying the assessment result. As illustrated in FIG. 10, if the determined part number is assessed to be different from the correct part number, the display screen includes entry fields for the target component and for comments, and the user can enter the target component and comments by operating operation receiver 11. Note that the target component may be automatically entered by information processor 16.

When the save button included in the assessment result display screen is tapped, information processor 16 stores the identification information of the target component and the assessment result in association with each other in storage 17 (S18a). If the part number determined in step S16a is different from the correct part number, comments entered on the display screen in FIG. 10 are also stored.

Next, the processes performed when the finish assessment is selected in step S12 will be described (i.e., steps S13b through S18b). Information processor 16 selects the second assessment model corresponding to the assessment selected in step S12 (the finish assessment) from among the pair of the first and second assessment models corresponding to the target component identified in step S11 (S13b).

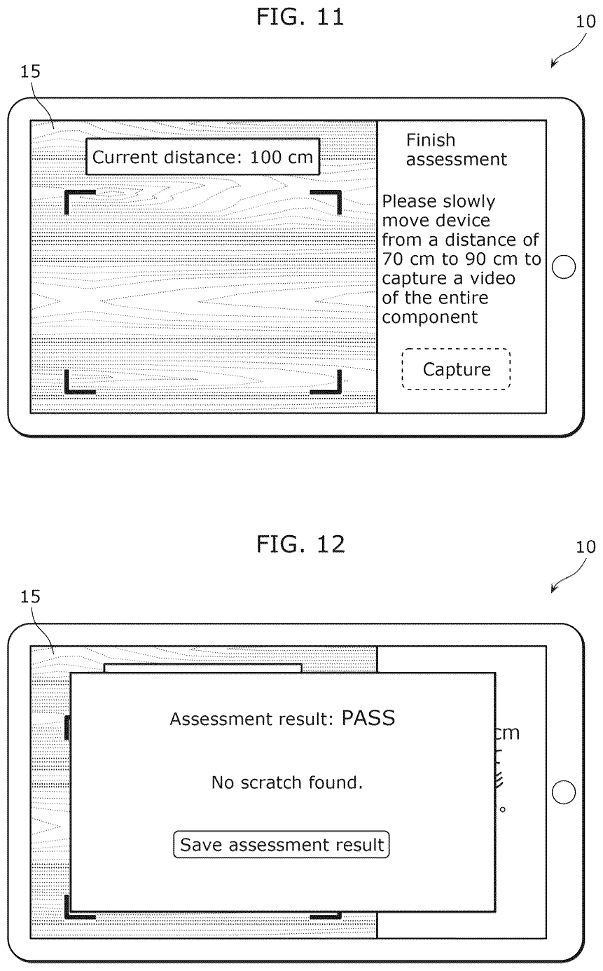

Next, information processor 16 displays, on display 15, the current distance to the target component and information instructing the user to capture a video (a plurality of images) from within a second distance range suitable for the finish assessment (S14b). FIG. 11 illustrates one example of display 15 showing information instructing the user to capture a video from within the second distance range. As illustrated in FIG. 11, information processor 16 displays information on display 15 instructing the user to slowly move assessment device 10 so as to scan the target component from end to end. When the second distance from the target component to assessment device 10 is d2, the second distance range is d2±a predetermined distance. For example, the second distance range is 80±10 (cm). Note that the second distance range may be asymmetric with respect to second distance d2. The second distance range is, for example, a distance range different from the first distance range suitable for the part number assessment, and is, specifically, a distance range farther from the target component than the first distance range.

When the user moves and the distance to the target component measured by distance measuring sensor 13 enters the second distance range, information processor 16 displays information on display 15 for camera 12 to capture a video of the target component (S15b).

Next, information processor 16 performs a second assessment process of assessing whether the interior material attached to the target component is attached in acceptable condition (for example, whether the interior material is tilted, scratched, or stained) by applying the second assessment model selected in step S13b to an image (frame) included in the video captured in step S15b (S16b). Specifically, information processor 16 assesses whether the interior material is attached in acceptable condition by inputting an image included in the video captured in step S15b into the second assessment model.

Next, information processor 16 displays the assessment result on display 15 (S17b). FIG. 12 illustrates one example of a screen displaying the assessment result. For example, as illustrated in FIG. 12, if the interior material is assessed to not include any scratches in step S16b, information processor 16 displays that the interior material does not include a scratch on display 15.

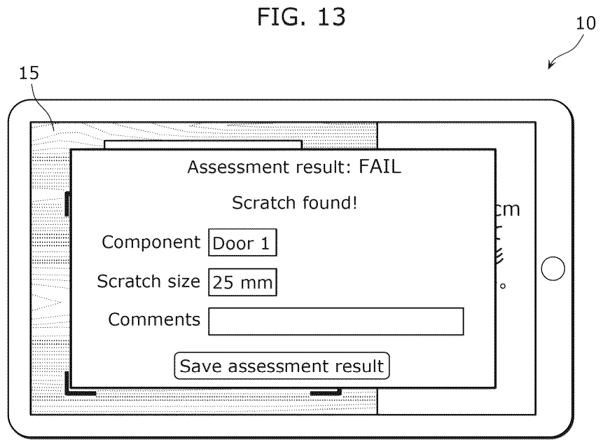

However, if the interior material is assessed to include a scratch in step S16b, information processor 16 displays that the interior material includes a scratch on display 15. FIG. 13 illustrates another example of a screen displaying the assessment result. As illustrated in FIG. 13, if the interior material is assessed to include a scratch, the display screen includes entry fields for the target component, the size of the scratch, and comments, and the user can enter the target component, the size of the scratch, and comments by operating operation receiver 11.

Note that the target component may be automatically entered by information processor 16. If the interior material is assessed to include a scratch, information processor 16 can identify the location of the scratch in the image and estimate the size of the identified scratch. The size of the scratch can be estimated based on the distance to the target component determined by distance measuring sensor 13 and the size (number of pixels) of the scratch in the image. The size of the scratch estimated in this way may be automatically input to the display screen described above by information processor 16.

When the save button included in the assessment result display screen is tapped, information processor 16 stores the identification information of the target component and the assessment result in association with each other in storage 17 (S18b). If the interior material is assessed to include a scratch in step S16b, the size of the scratch and comments entered on the display screen in FIG. 13 are also stored.

After the processing related to the part number assessment (steps S13a through S18a) or the finish assessment (steps S13b through S18b) is performed, information processor 16 updates the inspection information (S19). More specifically, information processor 16 changes the implementation status of completed assessments (i.e., assessments for which results have been stored) in the inspection information from “not done” to “done”.

Next, information processor 16 determines whether all assessments corresponding to the target component identified in step S11 have been completed (S20). If information processor 16 determines that not all assessments have been completed (No in S20), information processor returns to the assessment selection process of step S12.

However, if information processor 16 determines that all assessments have been completed (Yes in S20), information processor 16 determines whether assessments for all of the components have been completed (S21). Specifically, information processor 16 can determine whether assessments for all of the components have been completed by referring to the inspection information stored in storage 17.

If information processor 16 determines that assessments for all of the components have not been completed (No in S21), information processor returns to the target component identification process of step S11. However, if information processor 16 determines that assessments for all of the components have been completed (Yes in S21), the operation is ended.

As described above, assessment device 10 identifies a component based on the distance measured by distance measuring sensor 13 and an image captured by camera 12, and based on the identified component, information instructing the user to perform the first assessment process and information instructing the user to perform the second assessment process are displayed on display 15. The first assessment process is a process of assessing whether the interior material attached to the component is the interior material meant to be attached to that component by applying the first assessment model to an image captured by camera 12 while the distance measured by distance measuring sensor 13 is within the first distance range. The second assessment process is a process of assessing whether the interior material is in acceptable condition by applying the second assessment model to an image captured by camera 12 while the distance measured by distance measuring sensor 13 is within the second distance range.

Such an assessment device 10 can assist the user in efficiently inspecting the part numbers of interior materials.

### VARIATIONS

In the above embodiment, the part number assessment is made when the distance of assessment device 10 from the target component is within the first distance range, and the finish assessment is made when the distance of assessment device 10 from the target component is within the second distance range, which is farther from the target component than the first distance range. However, both the part number assessment and the finish assessment may be made when the distance of assessment device 10 from the target component is within approximately the same distance range.

For example, information processor 16 may make the part number assessment at a wide angle (for example, may simultaneously assess the part numbers of interior materials attached to a wall and a door) and may make the finish assessment at a wide angle or make the finish assessment with camera 12 zoomed in. In this case, the accuracy of the assessment can be improved by installing lighting equipment that is separate from assessment device 10 in the vicinity of the target component, or by the user holding lighting equipment that allows light to reach the target component.

In the above embodiment, assessment device 10 identifies the part number of an interior material (one example of a target object) while attached to a target component from among a plurality of components of a building. However, since assessment device 10 is capable of assessing whether or not a target object attached to a component is the predetermined object meant to be attached to that component and assessing whether or not the target object is in acceptable condition, assessment device 10 can be applied to target objects other than interior materials.

### Advantageous Effects

As described above, assessment device 10 includes: camera 12 that captures an image showing a component to which a target object is attached to cover a surface of the component; distance measuring sensor 13 that measures a distance to the component; and information processor 16. Information processor 16 performs: a first assessment process of assessing whether the target object attached to the component is a predetermined object meant to be attached to the component by applying a first assessment model to the image captured by camera 12 while the distance measured by distance measuring sensor 13 is within a first distance range; and a second assessment process of assessing whether the target object is in acceptable condition by applying a second assessment model different than the first assessment model to the image captured by camera 12 while the distance measured by distance measuring sensor 13 is within a second distance range.

Such an assessment device 10 can use an image to make a plurality of types of assessments depending on the distance to the target object at the time of capturing the image.

For example, assessment device 10 further includes display 15. For example, information processor 16 identifies the component based on the distance measured by distance measuring sensor 13 and the image captured by camera 12. For example, based on the component identified, at least one of information instructing a user to capture the image from within the first distance range or information instructing the user to capture the image from within the second distance range is displayed on display 15.

Such an assessment device 10 can instruct the user to perform assessment processes that need to be performed on the identified component.

For example, assessment device 10 further includes storage 17. For example, information processor 16: after identifying the component, identifies the predetermined object meant to be attached to the component by referring to storage 17; and in the first assessment process, assesses whether the target object attached to the component is the predetermined object identified or not.

Such an assessment device 10 can perform the first assessment process by identifying the predetermined object meant to be attached to the component.

For example, assessment device 10 further includes storage 17. For example, information processor 16 stores, in storage 17, identification information of an identified component in association with at least one of an assessment result of the first assessment process or an assessment result of the second assessment process.

Such an assessment device 10 can store the assessment results of assessment processes conducted on the identified component.

For example, assessment device 10 further includes light source 14 that illuminates the target object when camera 12 captures the image.

Such an assessment device 10 can reduce the influence of ambient light when capturing images.

For example, the target object is an interior material, and the component is any one of a floor, a wall, a ceiling, or a fixture.

Such an assessment device 10 can assess whether an interior material attached to a component such as the floor, a wall, the ceiling, or a fixture is the interior material meant to be attached to that component and assess whether or not the interior material is in acceptable condition.

An assessment method executed by a computer such as assessment device 10 includes: assessing whether a target object attached to a component to cover a surface of the component is a predetermined object meant to be attached to the component by applying a first assessment model to an image showing the component captured by camera 12 while a distance to the component measured by distance measuring sensor 13 is within a first distance range; and assessing whether the target object is in acceptable condition by applying a second assessment model different than the first assessment model to an image showing the component captured by camera 12 while a distance to the component measured by distance measuring sensor 13 is within a second distance range.

Such an assessment method can use an image to make a plurality of types of assessments depending on the distance to the target object at the time of capturing the image.

### OTHER EMBODIMENTS

Although the present disclosure has been described based an embodiment, the present disclosure is not limited to the above embodiment.

For example, the present disclosure may be realized as a client-server system in which the functions of the assessment device according to the above embodiment are allocated to client and server devices. In such cases, the client device is a portable terminal that captures images, accepts user operations, and displays identification results, while the server device is an information terminal that performs the first and second assessment processes using images. The assessment device may also be a robotic device that moves within the building or a drone device that flies within the building. In such cases, at least some of the user's operations are not required.

In the above embodiment, processes performed by a particular processor may be performed by a different processor. Moreover, the processing order of the processes may be changed, and the processes may be performed in parallel.

In the above embodiment, each element may be realized by executing a software program suitable for the element. Each element may be realized by means of a program executing unit, such as a central processing unit (CPU) or a processor, reading and executing a software program recorded on a recording medium such as a hard disk or semiconductor memory.

Each element may be realized by hardware. Each element may be a circuit (or integrated circuit). These circuits may be collectively configured as a single circuit and, alternatively, may be individual circuits. Moreover, these circuits may be general-purpose circuits or specialized circuits.

General or specific aspects of the present disclosure may be realized as a system, a device, a method, an integrated circuit, a computer program, or computer-readable recording medium, such as a CD-ROM, or any combination thereof.

For example, the present disclosure may be realized as an assessment method executed by a computer such as an assessment device. The present disclosure may be realized as a program for causing a computer to execute such an assessment method (i.e., a program for causing a general-purpose portable terminal to operate as the assessment device according to the above embodiment). The present disclosure may be realized as a computer-readable non-transitory recording medium having recorded thereon such a program.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### INDUSTRIAL APPLICABILITY

The present disclosure is applicable as an assessment device that can assess the color pattern of a target object in an image depending on the distance to the target object at the time of capturing the image.

1. An assessment device comprising:
a camera that captures an image showing a component to which a target object is attached to cover a surface of the component;
a distance measuring sensor that measures a distance to the component; and
an information processor, wherein
the information processor performs:
a first assessment process of assessing whether the target object attached to the component is a predetermined object meant to be attached to the component by applying a first assessment model to an image captured by the camera while the distance measured by the distance measuring sensor is within a first distance range; and
a second assessment process of assessing whether the target object is in acceptable condition by applying a second assessment model different than the first assessment model to an image captured by the camera while the distance measured by the distance measuring sensor is within a second distance range different from the first distance range.

2. The assessment device according to claim 1, further comprising:
a display, wherein
the information processor identifies the component based on the distance measured by the distance measuring sensor and the image captured by the camera, and
based on the component identified, at least one of information instructing a user to capture the image from within the first distance range or information instructing the user to capture the image from within the second distance range is displayed on the display.

3. The assessment device according to claim 2, further comprising:
storage, wherein
the information processor:
after identifying the component, identifies the predetermined object meant to be attached to the component by referring to the storage; and
in the first assessment process, assesses whether the target object attached to the component is the predetermined object identified or not.

4. The assessment device according to claim 2, further comprising:
storage, wherein
the information processor stores, in the storage, identification information of an identified component in association with at least one of an assessment result of the first assessment process or an assessment result of the second assessment process.

5. The assessment device according to claim 1, further comprising:
a light source that illuminates the target object when the camera captures the image.

6. The assessment device according to claim 1, wherein
the target object is an interior material, and
the component is any one of a floor, a wall, a ceiling, or a fixture.

7. An assessment method comprising:
assessing whether a target object attached to a component to cover a surface of the component is a predetermined object meant to be attached to the component by applying a first assessment model to an image showing the component captured by a camera while a distance to the component measured by a distance measuring sensor is within a first distance range; and
assessing whether the target object is in acceptable condition by applying a second assessment model different than the first assessment model to an image showing the component captured by the camera while a distance to the component measured by the distance measuring sensor is within a second distance range.

8. A non-transitory computer-readable recording medium having recorded thereon a program for causing a computer to execute the assessment method according to claim 7.
